(19) United States
(12) Patent Application Publication
(10) Pub. No.: US 2013/0015034 A1
(43) Pub. Date: Jan. 17, 2013

(54) DOUBLE VENTILATING CLUTCH ASSEMBLY

(71) Applicant: Thaveesak Boonpongmanee, Cleveland, OH (US)

(72) Inventor: Thaveesak Boonpongmanee, Cleveland, OH (US)

(21) Appl. No.: 13/181,570

(22) Filed: Jul. 13, 2011

(51) Int. Cl. F16D 25/04

(52) U.S. Cl. 192/85.03

(57) ABSTRACT

A clutch assembly with a first drum clutch and a second drum clutch supported by an adapter hub and arranged so that the second clutch is disposed concentrically inside the first clutch. Each drum clutch has an inflatable tube and a plurality of friction shoes disposed on the inflatable tube. Arranging two drum clutches concentrically increases the torque capacity of the clutch assembly without increasing its footprint.

### TECHNICAL FIELD

The present invention relates to drum-type clutches, and more particularly to a clutch assembly that incorporates more than one drum clutch.

### BACKGROUND OF THE INVENTION

Clutches and brakes used in industrial machinery and equipment may include a clutch having an inflatable annular tube that is mounted on a rigid annular rim. Friction shoes are connected with the tube in an annular array. When pressurized, the tube is expanded to press the friction shoes against a surface to provide a clutching or braking action.

Some applications may require clutches with a higher torque capacity. Although it is possible to increase the capacity of a clutch by increasing its size, certain applications have space restrictions that cannot accommodate the increased footprint of a larger clutch. Arranging multiple clutches in series to increase torque would also increase the footprint.

There is a desire to increase the torque capacity of a clutch without increasing its footprint.

### SUMMARY OF THE INVENTION

An embodiment of the invention is directed to a clutch assembly with a first drum clutch and a second drum clutch supported by an adapter hub and arranged so that the second clutch is disposed concentrically inside the first clutch. Each drum clutch has an inflatable tube and a plurality of friction shoes disposed on the inflatable tube.

Another embodiment is directed to a clutch assembly with a first ventilating drum clutch and a second ventilating drum clutch supported by an adapter hub and arranged so that the second clutch is disposed concentrically inside the first clutch. Each ventilating drum clutch has an inflatable tube mounted on a rigid rim and a plurality of friction shoes disposed on the inflatable tube.

A further embodiment is directed to a clutch system having a drum with a drum hub, a shaft that spins inside the hub, and a clutch assembly with a first ventilating drum clutch and a second ventilating drum clutch supported by an adapter hub and arranged so that the second clutch is disposed concentrically inside the first clutch. Each ventilating drum clutch has an inflatable tube mounted on a rigid rim and a plurality of friction shoes disposed on the inflatable tube. The friction shoes are engageable with the drum.

### BRIEF DESCRIPTION OF THE DRAWINGS

FIG. 1 is a perspective view of a ventilating constricting clutch used in one embodiment of the invention;

FIG. 2 is a perspective view of a ventilating expanding clutch used in one embodiment of the invention;

FIG. 3 is a representative cross-sectional view of a double ventilating clutch according to one embodiment of the invention;

FIG. 4 is a representative cross-sectional view of a double ventilating clutch according to another embodiment of the invention.

### DETAILED DESCRIPTION OF THE INVENTION

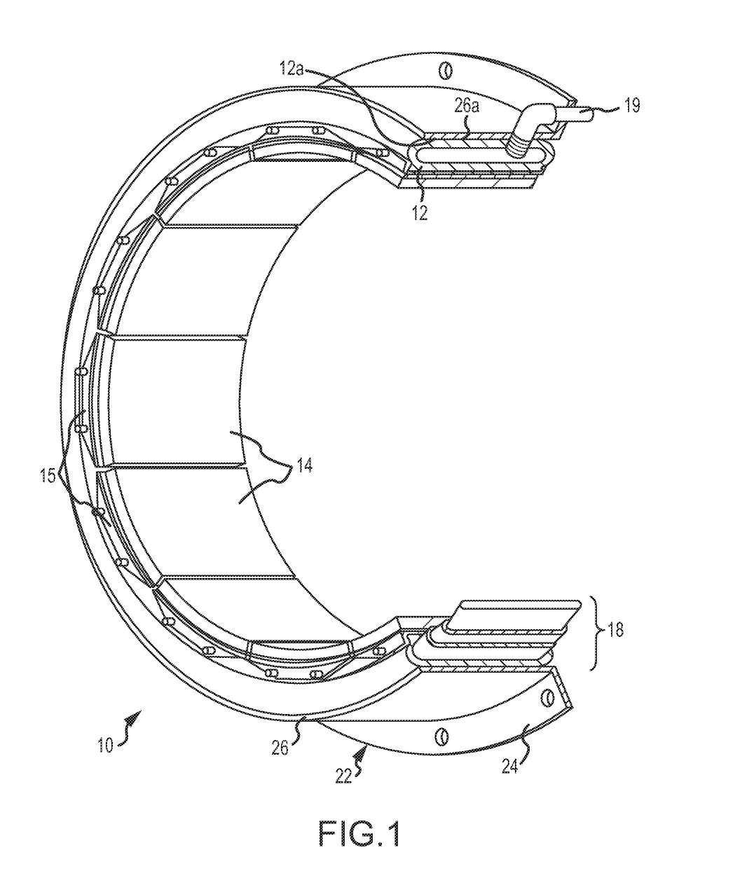

Referring now to the drawings, which are not intended to limit the invention, FIG. 1 illustrates a ventilating constricting clutch 10 that may be used in a clutch assembly 11 according to one embodiment of the invention. More specific details on one possible construction of the clutch 10 and preferred materials may be found in commonly-assigned U.S. Publication No. 2009/0114497, published on May 7, 2009, the disclosure of which is incorporated herein by reference in its entirety.

The clutch 10 may include an inflatable tube 12 and an annular array of friction shoes 14 disposed on backing plates 15 attached to the tube 12. The tube 12 have a generally flattened annular structure. To enable the clutch 10 to withstand relatively large torque forces between the tube 12 and the rim 22, one or more reinforced and/or non-reinforced layers 18 may be disposed in the tube 12. While a range of elastomers, including uncured thermoset and thermoplastic elastomers, may be used to construct the tube 12, thermoplastic elastomers provide the best blend of efficiency and integrity when joining the two ends. In one embodiment, a conduit 19 directs fluid pressure (i.e., air pressure) as air pressure, into the annular tube 12, causing the tube 12 to expand radially inwardly.

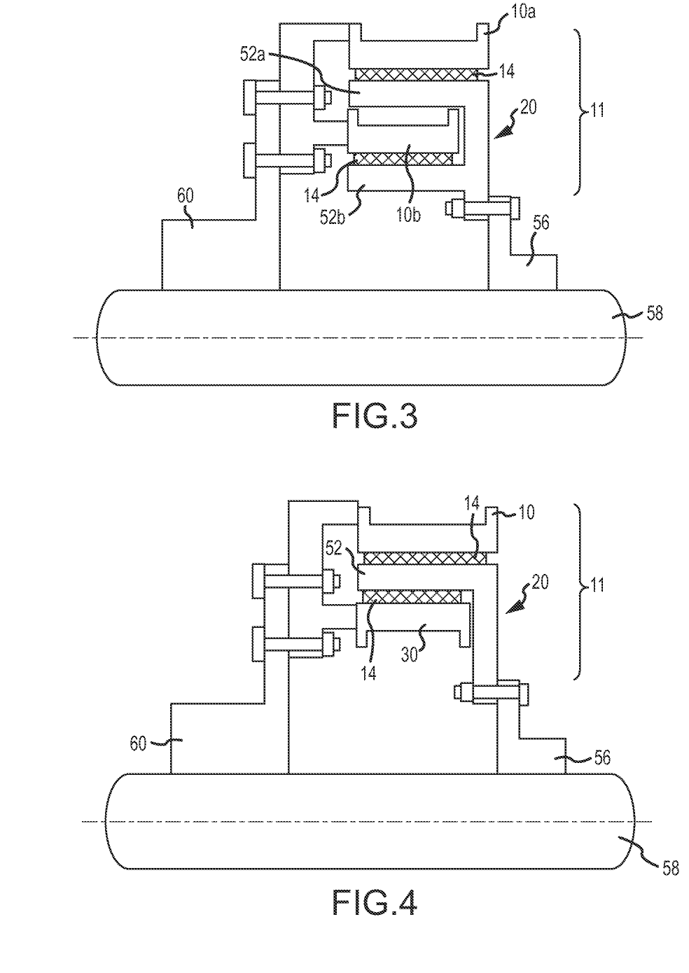

As shown in FIGS. 3 and 4, the friction shoes 14 are engageable with a surface of a drum 20 or other component whose motion is to be slowed down. Note that although the terms “clutch” and “clutch assembly” are used throughout this description, those of ordinary skill will understand that the clutch and assembly disclosed herein may be used in other applications, such as brake applications, without departing from the scope of the invention.

One embodiment of the clutch 10 may have a rigid annular metal rim 22 connected to the inflatable tube 12. For the constricting clutch 10, the tube 12 is disposed on an inner surface of the rim 22, and the friction shoes 14 face inwardly so they extend toward the center of the rim 22 when the tube 12 is inflated. In one embodiment, the rim 22 may have an annular mounting flange 24 for connecting the clutch 10 with an associated apparatus or support structure and a cylindrical web 26 with an inner surface 26a that is bonded to an outer surface 12a of the tube 12.

When the tube 12 is inflated through the conduit 19, the radial expansion of the tube 12 against the web 26 of the rigid rim 22 forces the backing plates 15, and therefore the friction shoes 14, inwardly against the drum 20 or other clutch component. The friction between the friction shoes 14 and the drum couple the drum 20 and the clutch 10 together. The resulting torque forces may retard the motion of the drum 20.

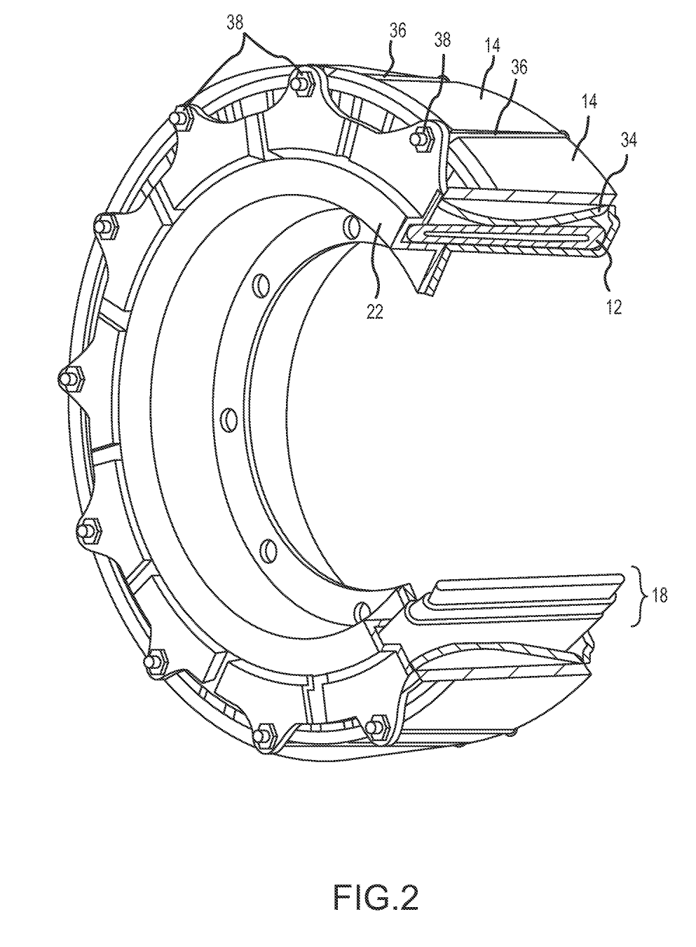

FIG. 2 shows a ventilating expanding clutch 30 that may be used in the clutch assembly 11 according to one embodiment of the invention Like the ventilating constricting clutch 10 described above, the expanding clutch 30 has the tube 12 and the friction shoes 14 that engage with an interior surface of the drum 20 when the tube 12 is inflated. However, the support structure of the expanding clutch 30 is different than the constricting clutch 10 to allow the friction shoes 14 to move radially outward.

More particularly, one embodiment of the expanding clutch 30 has a plurality of housing segments 32 attached to the rim 22 supporting the tube 12. The segments 32 may be designed to have an open construction and ventilating features to allow increased heat dissipation and flow of cooling air through the clutch 30. Backing plates 34 supporting the friction shoes 14 may also have an open construction. A plurality of torque bars 36 may be attached to the segments 32 with nuts 38 to hold the friction shoes 14 in place. The expanding design of this clutch 30 allows it to be used as a centrifugal clutch if desired.

When an assembly uses a single clutch to retard rotation of the drum 20, the friction shoes 14 contact only one surface of the drum 20, leaving the other surface of the drum 20 untouched. As shown in FIGS. 3 and 4, the inventive structure increases torque capacity by applying frictional forces on both the inner and the outer surfaces of the drum 2, thereby increasing the torque capacity without increasing the footprint of the clutch assembly 50.

The embodiment shown in FIG. 3 will now be described in greater detail. This embodiment of the clutch assembly 11 uses two ventilating constricting clutches 10a, 10b, that engage the drum 20. The clutches 10a, 10b are arranged concentrically to provide increased torque capacity without increasing the footprint of the clutch assembly 11.

The drum 20 may have two concentric walls 52a, 52b. A drum hub 56 is attached to the drum 20 and supports the drum 20 on a shaft 58. An adapter hub 60 supports the two clutches 10a, 10b so they are arranged concentrically, with each clutch 10a, 10b engaging a corresponding drum wall 52a, 52b. When the tube 12 in each clutch 10a 10b expands, the friction shoe assemblies 14 are forced radially inward toward the shaft 58 until the friction shoe assembles 14 engage their corresponding drum walls 52a, 52b. The resulting frictional forces slows rotation of the drum 20.

FIG. 4 shows the clutch assembly 11 according to another embodiment of the invention. This embodiment can be used with any drum 20 configuration because it does not require a drum 20 with two walls. Instead, the clutches 10, 30 are arranged to apply force to opposite sides of the same drum wall 52.

More particularly, the assembly 11 of FIG. 1 includes the constricting clutch 10, which applies force to the outer surface of the drum wall 52, and the expanding clutch 30, which applies force to the inner surface of the drum wall 52. When the tube 12 in the constricting clutch 10 inflates, it moves its friction shoes 14 radially inwardly toward the shaft 58. At the same time, when the tube 12 in the expanding clutch 30 inflates, it moves its friction shoes 14 radially outward away from the shaft 58. As a result, the drum wall 52 is trapped between the friction shoes 14 of both the constricting clutch 10 and the expanding clutch 30 Like the embodiment in FIG. 3, the assembly 11 of FIG. 4 has two clutches 10, 30 that are disposed in a concentric fashion, essentially doubling the torque capacity of a clutch assembly 11 having a given footprint size.

Note that in both embodiments shown in FIGS. 3 and 4, actuation of the clutches 10, 30 can be controlled in any manner. For example, instead of operating both clutches 10, 30 simultaneously, one of the clutches 10, 30 may be operated at a time, or both clutches 10, 30 may apply different forces to the drum 22. As a result, the inventive assembly 11 can apply a wider range of forces on the drum 22 to provide greater control over the drum 22 rotation.

By arranging multiple clutches 10, 30 concentrically, the inventive clutch assembly 11 can significantly increase the torque capacity of the assembly 11 without increasing its footprint. The concentric arrangement takes advantage of dead space in and around the drum 20 by placing another clutch 10, 30 in the space to provide additional torque capacity within the existing footprint of the assembly 11.

While the best modes for carrying out the invention have been described in detail, those familiar with the art to which this invention relates will recognize various alternative designs and embodiments for practicing the invention within the scope of the appended claims.

What is claimed is:

1. A clutch assembly, comprising:
a first drum clutch having a first inflatable tube and a first plurality of friction shoes disposed on the first inflatable tube;
a second drum clutch having a second inflatable tube and a second plurality of friction shoes disposed on the second inflatable tube; and
an adapter hub supporting the first and second drum clutches, wherein the second drum clutch is arranged concentrically inside the first drum clutch.

2. The clutch assembly of claim 1, wherein at least one of the first drum clutch and the second drum clutch is a ventilating clutch.

3. The clutch assembly of claim 1, wherein the first and second drum clutches are constricting clutches.

4. The clutch assembly of claim 1, wherein the first drum clutch is a constricting clutch and the second drum clutch is an expanding clutch.

5. The clutch assembly of claim 1, further comprising:
a first plurality of backing plates that support the first plurality of friction shoes, wherein the first plurality of backing plates are attached to the first inflatable tube; and
a second plurality of backing plates that support the second plurality of friction shoes, wherein the second plurality of backing plates are attached to the second inflatable tube.

6. The clutch assembly of claim 1, wherein at least one of the first and second inflatable tubes are disposed on a rim.

7. The clutch assembly of claim 6, wherein the rim has a mounting flange.

8. A clutch assembly, comprising:
a first ventilating drum clutch having a first inflatable tube and a first plurality of friction shoes disposed on the first inflatable tube, wherein the first inflatable tube is mounted on a first rigid rim;
a second ventilating drum clutch having a second inflatable tube and a second plurality of friction shoes disposed on the second inflatable tube, wherein the second inflatable tube is mounted on a second rigid rim; and
an adapter hub supporting the first and second drum clutches, wherein the second drum clutch is arranged concentrically inside the first drum clutch.

9. The clutch assembly of claim 8, wherein the first and second ventilating drum clutches are ventilating constricting clutches.

10. The clutch assembly of claim 8, wherein the first ventilating drum clutch is a ventilating constricting clutch and the second drum clutch is a ventilating expanding clutch.

11. The clutch assembly of claim 8, further comprising:
a first plurality of backing plates that support the first plurality of friction shoes, wherein the first plurality of backing plates are attached to the first inflatable tube; and
a second plurality of backing plates that support the second plurality of friction shoes, wherein the second plurality of backing plates are attached to the second inflatable tube.

12. The clutch assembly of claim 8, wherein at least one of the first and second rigid rims has a mounting flange.

13. A clutch system, comprising:
a drum having a drum hub;
a shaft that spins inside the drum hub; and
a clutch assembly having
a first ventilating drum clutch having a first inflatable tube and a first plurality of friction shoes disposed on the first inflatable tube and engageable with the drum, wherein the first inflatable tube is mounted on a first rigid rim;
a second ventilating drum clutch having a second inflatable tube and a second plurality of friction shoes disposed on the second inflatable tube and engageable with the drum, wherein the second inflatable tube is mounted on a second rigid rim; and
an adapter hub supporting the first and second drum clutches, wherein the shaft also spins inside the adapter hub and wherein the second drum clutch is arranged concentrically inside the first drum clutch.

14. The clutch system of claim 13, wherein
the drum has a wall having an outer surface and an inner surface; and
the first ventilating drum clutch is a ventilating constricting clutch that engages the outer surface and the second drum clutch is a ventilating expanding clutch that engages the inner surface.

15. The clutch system of claim 13, wherein
the drum has a first wall and a second wall disposed concentrically inside the first wall, and
the first and second ventilating drum clutches are ventilating constricting clutches, wherein the first ventilating drum clutch engages the first wall and the second ventilating drum clutch engages the second wall.

16. The clutch system of claim 13, wherein at least one of the first and second rigid rims has a mounting flange.
